(19) United States
(12) Patent Application Publication
(10) Pub. No.: US 2007/0076786 A1
(43) Pub. Date: Apr. 5, 2007

(54) Methods and apparatuses for processing spread spectrum signals

(76) Inventors: Surendran Konavattam Shanmugam, Calgary (CA); Jorgen Nielsen, Calgary (CA); Gerard Lachapelle, Calgary (CA); Robert Watson, Calgary (CA)

Correspondence Address: THELEN REID & PRIEST, LLP, P. O. BOX 640640, SAN JOSE, CA, 95164-0640, US

(21) Appl. No.: 11/520,774

(22) Filed: Sep. 12, 2006

Related U.S. Application Data
(60) Provisional application No. 60/716,530, filed on Sep. 14, 2005.

(51) Int. Cl. H04B 1/00

(52) U.S. Cl. 375/148; 375/150

(57) ABSTRACT

A method and apparatus of processing the received spread spectrum signals using an innovative pre-filtering and multi-correlation differential detection (MCDD) technique is disclosed. The primary embodiment of the invention comprises of a pre-filter and pluralities of complex differential detectors for primary processing of SS signal. Other embodiments of the method and apparatus include pre-filter bank, correlator bank and correlation combiner. More specifically (but not limited to), it is directed towards to the enhancement of acquisition and/or tracking performance of SS receivers.

### CROSS-REFERENCE TO RELATED APPLICATION

This application is a non-provisional application claiming priority to U.S. Provisional Application Ser. No. 60/716,530, filed on Sep. 13, 2005, entitled “Differential Signal Processing Schemes for Enhanced GPS Acquisition,” which is herein incorporated by reference in its entirety.

### FIELD OF THE INVENTION

Embodiments of the invention relate generally to the field of processing spread spectrum signals and more specifically to methods and apparatuses for effective signal acquisition and receiver tracking for spread spectrum signals.

### BACKGROUND OF THE INVENTION

Spread spectrum (SS) systems employ various techniques to spread energy generated at a given frequency or frequency band over a much wider band of frequencies. These techniques may be employed for many reasons including providing increased resistance to natural or intentional interference. In telecommunication applications, SS systems may employ direct-sequence (DSSS), frequency hopping, or a hybrid of these techniques, among others. SS communications systems use a sequential noise-like signal structure to spread the typically narrowband information signal over a relatively wideband range of radio frequencies. The receiver correlates the received signals to retrieve the original information (e.g., telecommunication signal). Such systems decrease potential interference to other receivers while achieving an acceptable degree of privacy. Moreover, such systems are ideal candidates for ranging and target detection. For instance, global navigation satellite systems (GNSS) such as Global Positioning System (GPS) and the European Geostationary Navigation Overlay System (EGNOS), utilize the SS signal received from multiple satellites to accurately estimate the position of the user. Additionally, SS systems are highly advantageous for applications that require robustness towards thermal noise, interference and multipath. For example, code division multiple access (CDMA) systems and ultra wideband (UWB) systems utilize the SS signal characteristics for thermal noise and interference immunity and to provide multiple access.

In a SS system, the transmitted SS signal reaches the receiver with an unknown timing and frequency offset. For example, even after down-conversion, the received SS signal is not pure baseband as there is still some residual frequency offset due to receiver motion, transmitter motion, oscillator inaccuracies, or a combination thereof. Additionally, the SS signal incurs an unknown time delay prior reaching the SS receiver owing to the transmitter/receiver separation. In conventional SS receiver systems, the time delay and frequency offset are determined prior to any further processing. That is, a two-dimensional search in time and frequency is performed to provide the initial estimates of code/frequency offset. The acquisition and tracking unit accomplishes the task of coarse and fine timing and frequency estimation in a SS receiver. The timing offset is determined by correlating the received SS signal with pluralities of locally generated signals having varying start timing (e.g., code offset) and finding the maximum of the output, while the frequency offset is determined by demodulating the received SS signal with pluralities of locally generated intermediate carrier signals to determine the maximum of the output. When the estimates are within the pull-in region, the SS receiver initiates the tracking unit that accurately tracks these parameters in a continuous fashion.

As discussed above, SS transmitters spread the transmit power over a relatively large signal bandwidth and consequently the received signal power is often below the thermal noise floor. Hence, the acquisition and tracking of SS signals, especially in low-transmit power situations, is a difficult task. The acquisition and tracking performance of SS receivers is restricted by such factors as signal attenuation (e.g., indoors), interferences emanating from similar SS receivers and other co-existing narrow and wideband systems, and also intentional interference (e.g., jamming). These restrictions to effective acquisition and tracking can be reduced by increasing the coherent observation period. However, the coherent observation period is also severely limited by factors such as transmitter and receiver oscillator stability, time varying propagation characteristics, transmitter and/or receiver dynamics, and data modulation. Furthermore, increasing the coherent integration period reduces the frequency search bin size, which significantly increases the search space and therefore, search complexity. Moreover, other issues like interference from similar SS receivers operating in the same spectrum can also be a detriment to effective acquisition and tracking.

Such disadvantages of conventional, standard SS receivers, which may cause operational failure in degraded signal environments, may be overcome using high sensitivity (HS) SS receivers equipped with significant signal processing capabilities. Such HSSS receivers are able to acquire and track much weaker SS signals. For example, the HS-GPS receivers may either utilize short coherent integration followed by a large number of noncoherent accumulations or increase coherent integration using the information obtained through dedicated backbone networks. Highly parallel architectures of searching code/frequency offset using massive number of correlators may also be utilized to reduce the mean acquisition time.

Such schemes retain the disadvantage of requiring some type of two-dimensional search in the time/frequency domain.

### BRIEF DESCRIPTION OF THE DRAWINGS

The invention may be best understood by referring to the following description and accompanying drawings that are used to illustrate embodiments of the invention. In the drawings:

FIG. 1 illustrates the acquisition and tracking unit (ATU) of a SS receiver in accordance with the prior art;

FIG. 2 illustrates, generally, the functionality of a signal conditioning block of the ATU described in reference to FIG. 1 in accordance with the prior art;

FIG. 3 illustrates the acquisition and tracking unit (ATU) of a SS receiver in accordance with one embodiment of the invention;

FIG. 4 illustrates the components of a signal processing unit for an ATU of a SS receiver in accordance with one embodiment of the invention;

FIG. 5 illustrates a method for effecting SS signal processing in accordance with one embodiment of the invention;

FIG. 6 illustrates a time domain implementation of a pre-filter in accordance with one embodiment of the invention;

FIG. 7 (a) and FIG. 7 (b) illustrate the pre-filter output provided to a bank of CDDs where the current complex samples are multiplied by the delayed complex conjugated samples in the individual differential detector units in accordance with one embodiment of the invention;

FIG. 8 illustrates the secondary pre-filtering operation effected subsequent to a sample being subjected to a complex differential detection operation;

FIG. 9 (a) and FIG. 9 (b) illustrate the input of the transformed PRN codes to the modified correlator in accordance with one embodiment of the invention;

FIG. 10 illustrates the collective output from the modified correlator bank being input to the integrator bank in accordance with one embodiment of the invention;

FIG. 11 illustrates the collective outputs of the integrator bank input to the correlation combiner, and the combined output supplied as inputs to the microcontroller in accordance with one embodiment of the invention;

FIGS. 12 (a) through 12 (d) illustrate correlation combining techniques in accordance with alternative embodiments of the invention;

FIG. 13 illustrates a functional block diagram of a digital processing system in accordance with one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

System Overview

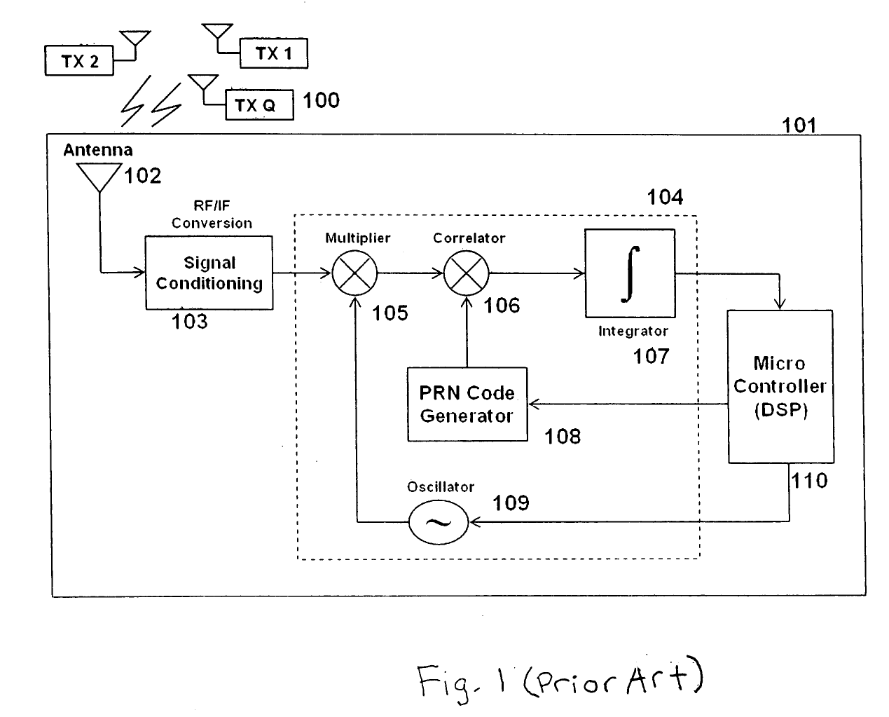

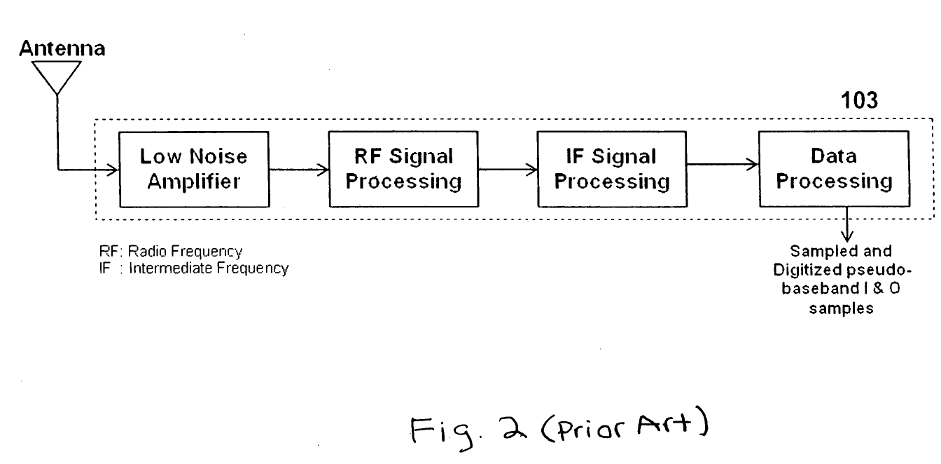

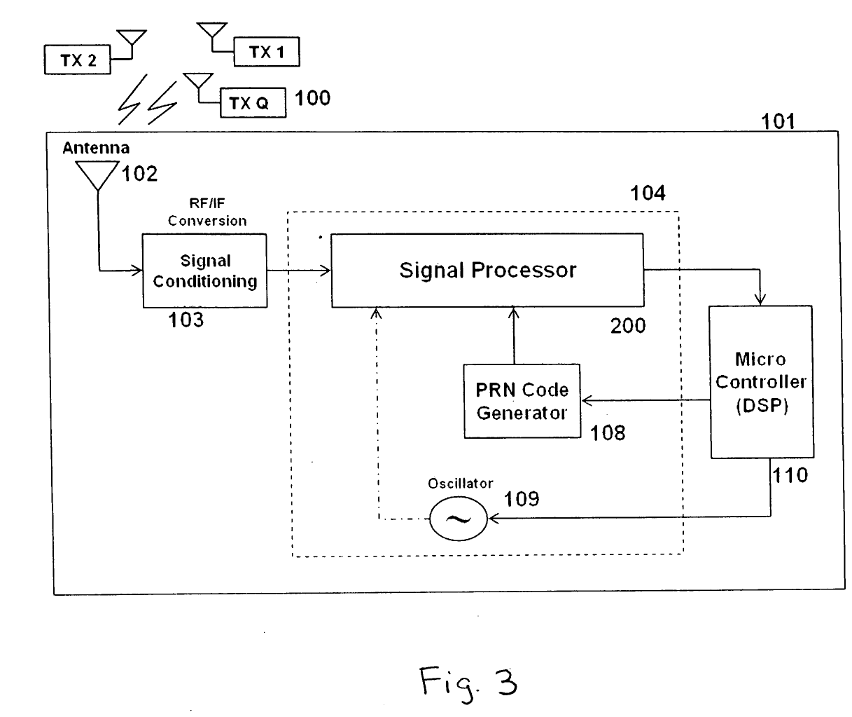

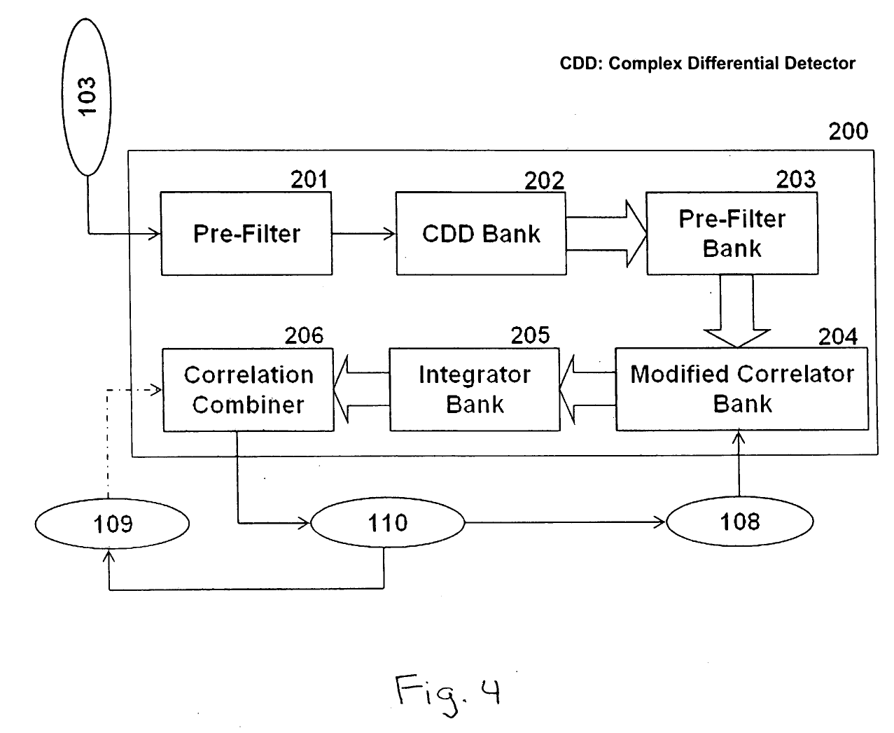

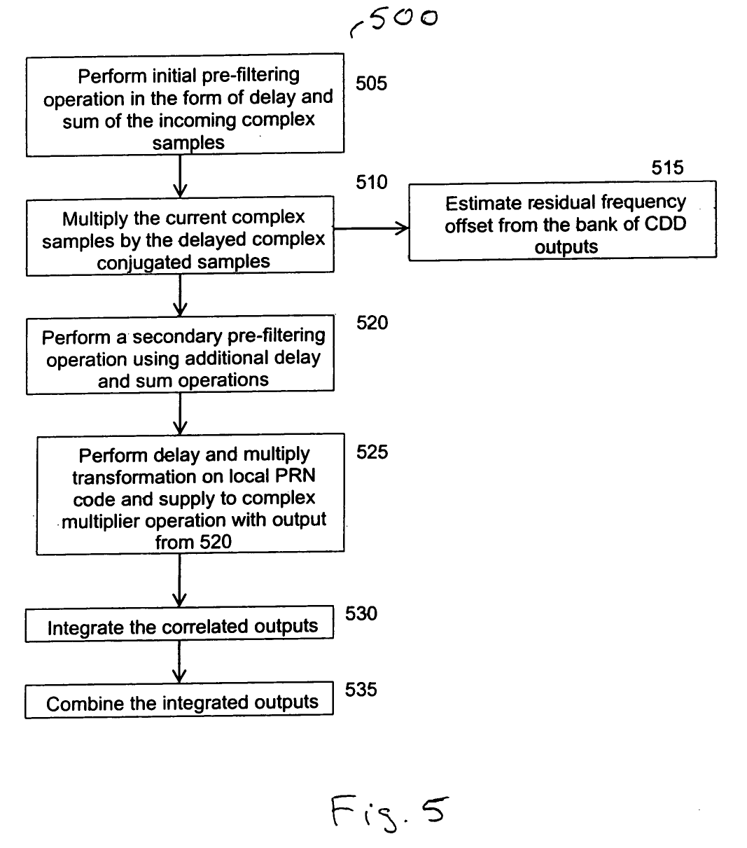

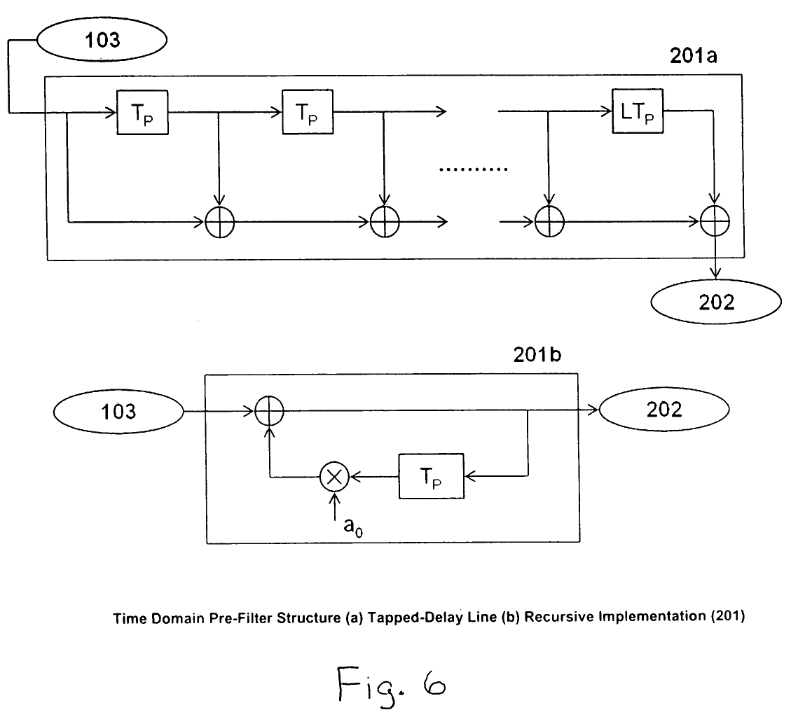

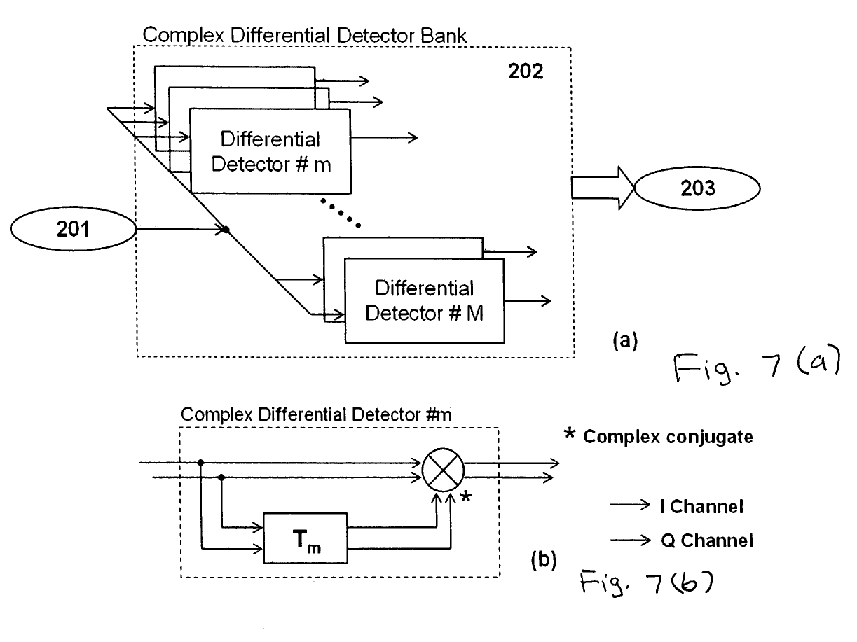

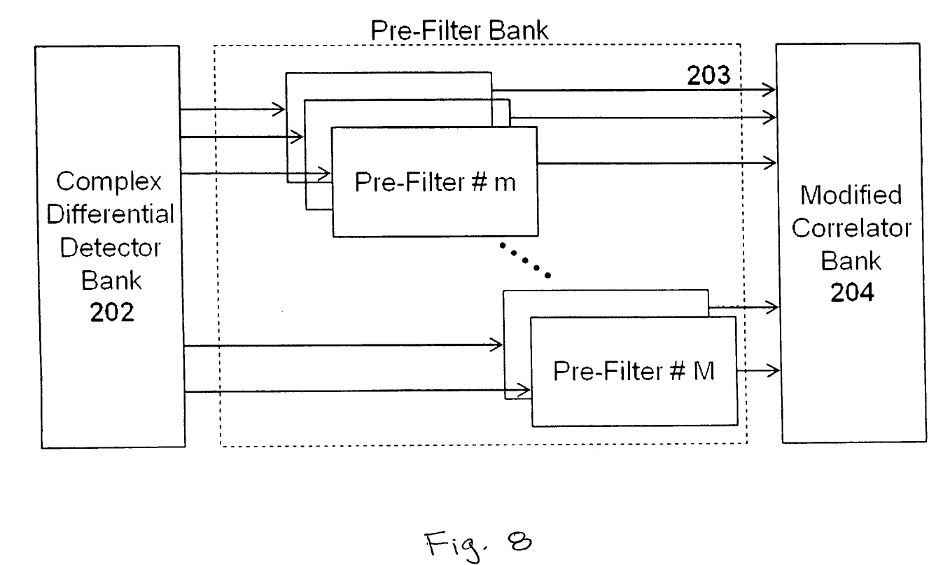

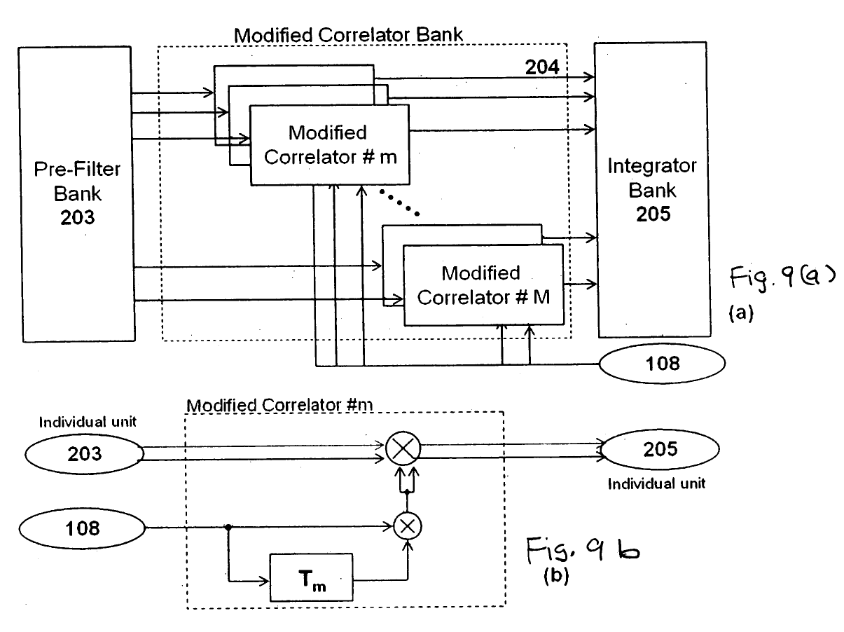

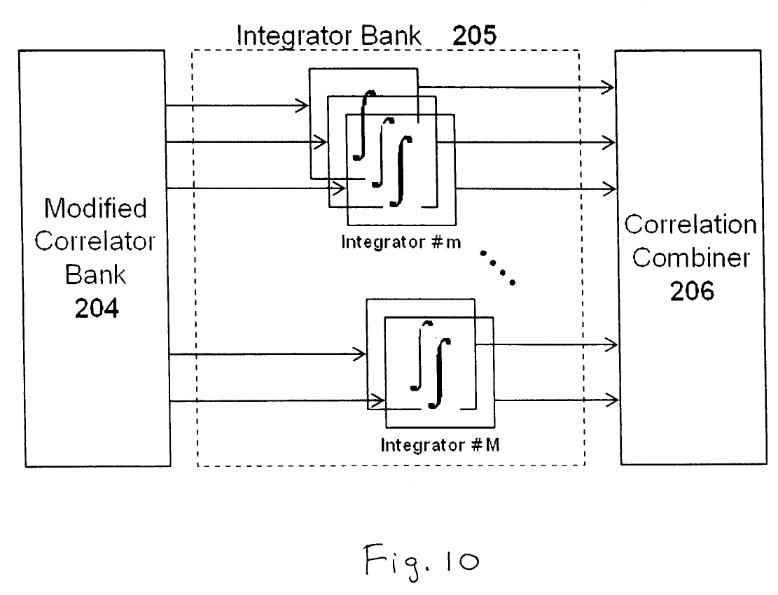

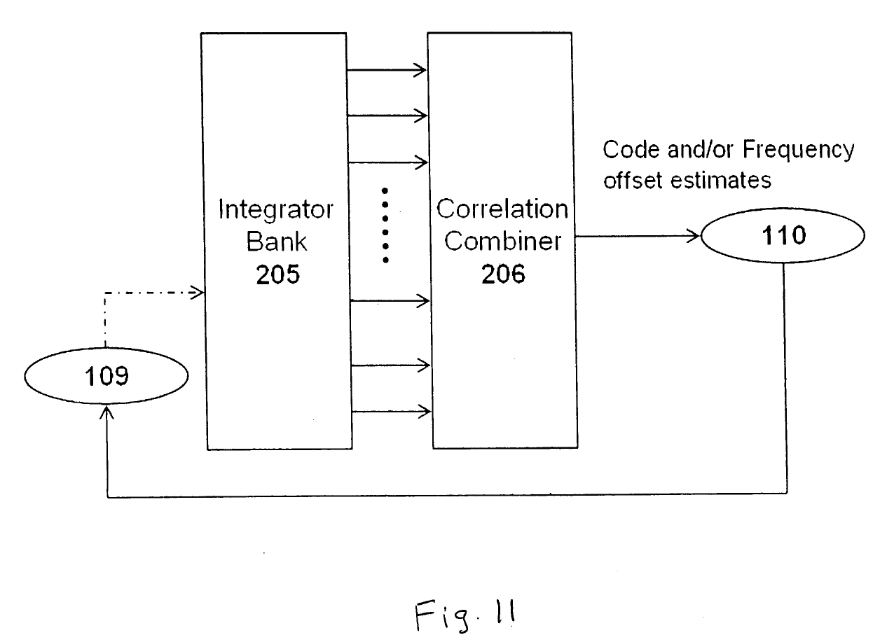

FIG. 1 illustrates the acquisition and tracking unit (ATU) of a SS receiver in accordance with the prior art. The ATU allows for acquiring and tracking of SS signals from one of a plurality of SS transmitters. The following description in reference to FIG. 1, describes the processing of a single received SS signal. However, it would be apparent to those skilled in the art that with suitable modifications, the systems and apparatuses described can be readily applied to acquire multiple SS signals simultaneously.

As shown in FIG. 1, the ATU 101 receives the SS signal from a SS transmitter of interest (e.g., transmitter 100) in addition to other SS signals from other transmitters (e.g., transmitter 1 and transmitter 2). An antenna 102 receives the composite SS signals and provides the composite SS signals to the signal conditioning unit 103. Signal conditioning unit 103 amplifies, filters, and down converts the received composite radio frequency (RF) SS signal to baseband for processing.

FIG. 2 illustrates, generally, the functionality of a signal conditioning unit 103 of the ATU described in reference to FIG. 1 in accordance with the prior art. As shown in FIG. 2, the signal conditioning unit 103 provides low noise amplification, RF signal processing, intermediate frequency (IF) signal processing, and data processing. The output of signal conditioning unit 103 is sampled and digitized inphase (I) and quadrature (Q) samples downconverted to the baseband. This is essentially a pseudo baseband because of the residual frequency offset component. Referring again to FIG. 1, the output of signal conditioning unit 103 is supplied to the processing block 104. The processing block 104 includes a multiplier 105, a correlator 106, an integrator 107, a Pseudo-Random Noise (PRN) code generator 108 and an oscillator 109.

Multiplier 105 multiplies the incoming complex samples by a complex residual frequency carrier received from the oscillator 109. The output of the multiplier 105 is supplied to the correlator 106. The correlator 106 correlates the complex samples with a locally generated replica of the PRN code obtained from the PRN code generator 108. The output of the correlator 106 is coherently integrated in the integrator 107. The output of the integrator 107 is input to a micro controller 110. The micro controller 110 generates the required information for code/frequency acquisition or tracking including both carrier and code phase information.

The SS receiver operates in two modes namely the acquisition and tracking modes. The ATU 101 initially operates in the acquisition mode where it performs a serial or a parallel search by trying different combinations of residual frequency and code phase until the output of the integrator 107 exceeds a certain predefined threshold level, indicating that a match has been obtained for the particular SS transmitter. For multiple SS transmitters the search is typically performed in a parallel fashion (e.g., GNSS). Generally, during acquisition mode, the PRN code phase is allowed to vary for each residual frequency and is exhausted for other residual frequency offsets. For every combination of PRN code phase and frequency offset the output of integrator 107 is tested in the micro controller 110. Once the threshold is exceeded, the micro controller 110 sets the flag for tracking mode.

In the tracking mode, the ATU 101 operates to continuously update the code phase and residual frequency. Code phase tracking is generally assisted in a well-known manner using early and late PRN code generators respectively, and may also use punctual code generator. The micro controller 110 reduces the phase delay if the received complex samples correlate better with early code and vice versa. Carrier tracking can be accomplished through frequency or phase tracking. The micro controller 110 typically increases the phase or frequency by examining the phase rotation at the output of integrator 107. Additionally, the unit also aids in demodulation of data encoded in the SS transmitter using the punctual code. For longer observation time, the micro controller 110 processes the output from integrator 107 coherently using external aiding information. Alternatively, the micro controller 110 processes the output from integrator 107 noncoherently.

FIG. 3 illustrates the ATU of a SS receiver in accordance with one embodiment of the invention. As shown in FIG. 3, the ATU 101 includes a signal processing unit 200 that replaces the multiplier, correlator, and integrator of the prior art scheme discussed above in reference to FIG. 1. For one embodiment of the invention, the signal processing block 200 conditions the complex pseudo baseband samples prior to providing the conditioned samples (output signals) to the micro controller 110. For one such embodiment, the signal processing unit 200 does not necessarily require the output of oscillator 109 while in the acquisition mode. This loose dependence is indicated by the dashed line between the oscillator 109 and signal processing unit 200.

For one embodiment of the invention, the signal processing unit 200 includes one or more complex differential detectors (CDDs) and one or more pre-filtering blocks that effect the conditioning of the complex pseudo baseband samples. For one such embodiment, an initial pre-filter is matched to the spectrum of the incoming signal in order to suppress noise by averaging. That is, since the signal is periodic whereas the noise is aperiodic, the initial pre-filter will enhance the signal (e.g., relative to the noise).

FIG. 4 illustrates the components of a signal processing unit for an ATU of a SS receiver in accordance with one embodiment of the invention. As shown in FIG. 4, the signal processing unit 200 includes an initial pre-filter 201 which receives the complex pseudo baseband samples from signal conditioning unit 103 as discussed above. The pre-filter 201 processes the samples to enhance the pre-detection signal-to-noise ratio (SNR) and provides the resultant enhanced signal to a CDD bank 202. For various alternative embodiments of the invention, CDD bank 202 may include one or more CDDs. For one embodiment, each of the CDDs multiplies the current samples with the delayed, complex conjugated samples. The collection of outputs from CDD bank 202 is provided to the secondary pre-filter bank 203. For various alternative embodiments of the invention, the pre-filter bank 203 may include one or more pre-filters. For one such embodiment, the pre-filters of the pre-filter bank 203 function similarly to the initial pre-filter 201. For one embodiment of the invention, the pre-filter bank 203 is comprised of higher order filters than the initial pre-filter 201. That is, the initial pre-filtering is limited by the time-varying phase and navigation data. This may limit the filter order in some applications (e.g., the filter order may be limited to approximately 20 in GPS systems, assuming the data polarity can change 50% of the time). In view of time varying phase, the filter order may be dependent on residual frequency offset. Typically, the order may be limited by data transition rather than residual frequency error. The secondary pre-filtering bank may be higher order as the time-varying phase and data modulation are eliminated during the CDD operation. However, the filter order for the secondary pre-filtering may be limited by code Doppler. For example, with a code Doppler of 6 chips/second, the filter order may be 1/6 or approximately 150.

The signal from each CDD is processed in a parallel fashion over the entire bank. The pre-filter bank 203 enhances the signal in a similar fashion as the initial pre-filter 201.

The collective output of the pre-filter bank 203 is fed to the modified correlator bank 204. The modified correlator bank 204 is comprised of individual modified correlators, which obtain the primary PRN code from PRN code generator 108 and perform delay-and-multiply operations similar to the operation performed in the CDD bank 202. The modified correlator bank 204 provides signal correlation to determine timing offset. The collective output of the modified correlator bank 204 is supplied to the integrator bank 205. The integrator bank 205 consists of individual integrator units each of which functions similarly to that of the integrator unit 107 discussed above.

As shown in FIG. 4, for one embodiment of the invention, the collective outputs from the integrator bank 205 are supplied to the correlation combiner 206. The correlation combiner 206 combines the individual outputs of the integrator bank 205 to suppress the noise and other interferences. Finally, the output of correlation combiner 206 is supplied to the micro controller 110 where it is tested against a pre-defined threshold to determine the code phase. Various methods of determining the residual frequency in accordance with alternative embodiments of the invention will be discussed below.

Signal Processing Method

FIG. 5 illustrates a method for effecting SS signal processing in accordance with one embodiment of the invention. Process 500, shown in FIG. 5, begins at operation 505 in which an initial pre-filtering operation implemented (but not limited to) in the form of delay and summation of the incoming pseudo baseband complex samples from the signal conditioning unit. For one embodiment of the invention, the incoming complex samples are delayed by an integer multiple of the PRN code repetition duration. That is, in an SS transmitter, the data or preamble signal is modulated with a PRN code generated at a much higher rate. For some applications (e.g., GPS systems), the entire PRN code or multiples thereof, is transmitted for every data bit. Therefore, the resultant signal, after SS modulation, is a repetitive PRN code signal, whose polarity is determined by the data bits. The PRN code signal repetition duration may be expressed as T_{P}=N_{C}T_{C}. Where T_{P} is the PRN code signal repetition duration; N_{C} is the period of the underlying PRN code (or PRN code length in chips) and T_{C} is the duration of one chip in the PRN code signal. The pre-filtering operation 505 delays the incoming complex samples from the signal conditioning unit by an integer multiple of code repetition duration T_{P} and sums them. If the number of delay operations is L, then the filter delay may be expressed as, T_{L}=LT_{P}=L(N_{C}T_{C} ). The number of delay operations L and hence the total filter delay T_{L} is limited by the navigation modulation and the dynamics of the received SS signal. The basis for the advantage of implementing such a pre-filter operation is that the received signal is periodic (e.g., with period T_{P}) and therefore adds constructively, whereas the noise and other interferences are generally aperiodic and therefore add destructively. This means that, except for cases of periodic interference, the pre-filter operation results in an enhancement of signal component. Theoretically, the gain achieved by such a pre-filter may be expressed by G₁=10log₁₀(L) but, the practical gain is limited by data transition and transmitter/receiver constraints. The pre-filtering operation 505 achieves this gain without increasing the integration time in the integrator unit as required of prior art schemes.

For one embodiment of the invention, the pre-filtering operation reduces the bandwidth on the final low pass signal after despreading by a factor of (LT_{P})⁻¹ Hz. However, the pre-filter has a periodic response (e.g., a comb response) of T_{P}⁻¹ Hz with the bandwidth of (LT_{P})⁻¹ Hz. For one such embodiment of the invention, the frequency search is incremented in steps that are smaller than (LT_{P})⁻¹ Hz within ±T_{P}⁻¹ Hz to properly despread the received SS signal.

FIG. 6 illustrates a time domain implementation of a pre-filter in accordance with one embodiment of the invention. As shown in FIG. 6, the pre-filter may be implemented using a tapped delayed line structure 201a or using a recursive structure 201b. In recursive structure, the parameter a₀ can take values close to 1. For example, for one embodiment of the invention, the parameter a₀ may have the value 0.85.

Referring again to FIG. 5, at operation 510 the currently received pseudo baseband samples are multiplied by the delayed complex conjugated samples in each of one or more CDDs. FIG. 7 (a) and FIG. 7 (b) illustrate the pre-filter output provided to a bank of CDDs where the current complex samples are multiplied by the delayed complex conjugated samples in the individual differential detector units in accordance with one embodiment of the invention. FIG. 7 (a) illustrates a bank of CDDs while FIG. 7 (b) illustrates, in more detail, a CDD of the bank CDDs.

The individual differential detection delay (i.e. Tₘ) can either be an integer or fractional delay of the chip duration T_{C} (i.e. Tₘ=mT_{C}) and could take values larger than the code repetitive period N_{C}. For one embodiment of the invention, the resulting samples are repetitive PRN code with a constant phase offset (except for the data boundaries). That is, the time varying phase caused by the residual frequency offset and data modulation is transformed into a phasor. The phasor or the phase offset at the output of individual differential detectors embodies the time-varying phase over the delay Tₘ.

Therefore, while the frequency information is lost in individual differential detector outputs, the frequency information is still present across the differential detection outputs. But, the residual frequency carrier is now being sampled at integer or fractional multiples of Tₘ as opposed to T_{S}, which is the sampling duration.

At operation 515 the residual frequency is estimated by processing the outputs of across each CDD of the CDD bank. That is, when the PRN code is stripped off, the resulting CDD outputs carry only the frequency information.

For one embodiment of the invention, the individual differential detection delay Tₘ, or integer multiples of it, is set to the code repetitive period N_{C} (i.e. Tₘ=N_{C}), and the PRN code is stripped off in a differentially coherent fashion. Thus, the subsequent outputs carry only the frequency information, which can be processed to estimate frequency offset that is independent of code estimation. Note that, the transmitted PRN code in the received SS signal is eventually transformed after the differential detection output.

At operation 520 a secondary pre-filtering operation is performed to effect additional delay and sum operations by inputting the individual outputs of the CDD bank to a pre-filter bank. FIG. 8 illustrates a pre-filtering operation effected subsequent to a sample being subjected to a complex differential detection operation. As shown in FIG. 8, the collective outputs of the CDD bank are supplied to bank of pre-filters. The SS signal was transformed by the CDD bank while leaving the periodic property of the underlying PRN code intact. Therefore, because the differential detection effectively removed the time-varying phase, the number of delay and sum operations or the number of recursive summations may take a much higher value than those in the initial pre-filter operation 505. For example, as discussed above, the order may be 20 for the initial pre-filtering and 150 for the secondary pre-filtering depending upon the specific application.

The ultimate order of the individual pre-filter units in the pre-filter bank may be limited by the code Doppler and second order transmitter/receiver constraints. The individual pre-filter units in the pre-filter bank assume a structure similar to that of the pre-filter of the initial pre-filter operation. The individual gain obtained from the secondary pre-filtering operation in the individual pre-filter units is given by G₂=10log₁₀(W), where W is the number of delay and sum or the number of recursive summation operations. For one embodiment of the invention, the individual filter delays may be an integer multiple of code repetitive period N_{C}T_{C} (i.e. T_{W}=wN_{C}T_{C}).

At operation 525 the collective outputs from the pre-filter bank are supplied to the modified correlation bank where a delay and multiply transformation operation is effected on the original PRN code (i.e., the PRN code from the PRN code generator). The transformed PRN code is then supplied to the complex multiplier. FIG. 9 (a) and FIG. 9 (b) illustrate the input of the transformed PRN codes to the modified correlator in accordance with one embodiment of the invention. The complex multiplier multiplies the I and Q samples from the pre-filter bank with the same modified PRN code and supplies the output to the integrator bank. For one embodiment of the invention, the properties of the PRN code are exploited to reduce the operations involved in generating the bank of modified PRN outputs in the modified correlation bank. For example, the GPS LI PRN codes are derived from Gold sequences. The Gold sequences maintain low three-level cross-correlation (e.g., for 1023, the cross-correlation values are −1, −65, and 63). The shift-and-multiply property, when applied to the GPS PRN codes, resulted in a modified C/A code sequence with similar three-level correlation values. The correlation function provided an auto-correlation main peak having the same value for all of the modified PRN codes, and an auto-correlation side peak having different values for all of the modified PRN codes. Thus, the summed correlation outputs provide an enhanced auto-correlation main peak and a degraded (e.g., canceled) side peak. This provides significant auto-correlation side peak suppression. Similarly, cross-correlation peaks tend to add destructively, effecting significant cross-correlation suppression.

For one embodiment of the invention, as shown in FIG. 9 (b), for example, the delay-and-multiply operation produces the same modified PRN code for Tₘ₁=mT_{C} and Tₘ₂=(N_{C}−m+2)T_{C}. Similarly, owing to the PRN code periodicity we would expect the same modified PRN code for Tₘ₁=mT_{C} and Tₘ₂=(N_{C}+m)T_{C}.

At operation 530 the collective correlator outputs from the modified correlation bank are supplied to the integrator bank. The individual integrator units in the integrator bank are similar and perform the same function as that of the integrator 107 discussed above in reference to FIG. 1. FIG. 10 illustrates the collective output from the modified correlator bank being input to the integrator bank in accordance with one embodiment of the invention. This assumes an integrate and dump operation. For one embodiment of the invention effecting code independent, frequency estimation, the correlator bank is not required as the transmitted PRN code is stripped off in the received SS signal as described earlier in reference to operation 510.

At operation 535, the collective integrator outputs are then fed to the correlation combiner where they are combined. The combined integrator outputs are then input to the microcontroller as discussed above. FIG. 11 illustrates the collective outputs of the integrator bank input to the correlation combiner, and the combined output supplied as inputs to the microcontroller in accordance with one embodiment of the invention.

Exemplary Embodiments

As discussed above, the combining of the collective integrator outputs, to suppress noise and other interferences, may be effected in a variety of ways in accordance with various alternative embodiments of the invention. For example, in accordance with various embodiments of the invention, the combining of the integrator outputs may be effected through coherent correlation combining, differential correlation combining, non-coherent correlation combining, and combinations thereof, among other combination techniques

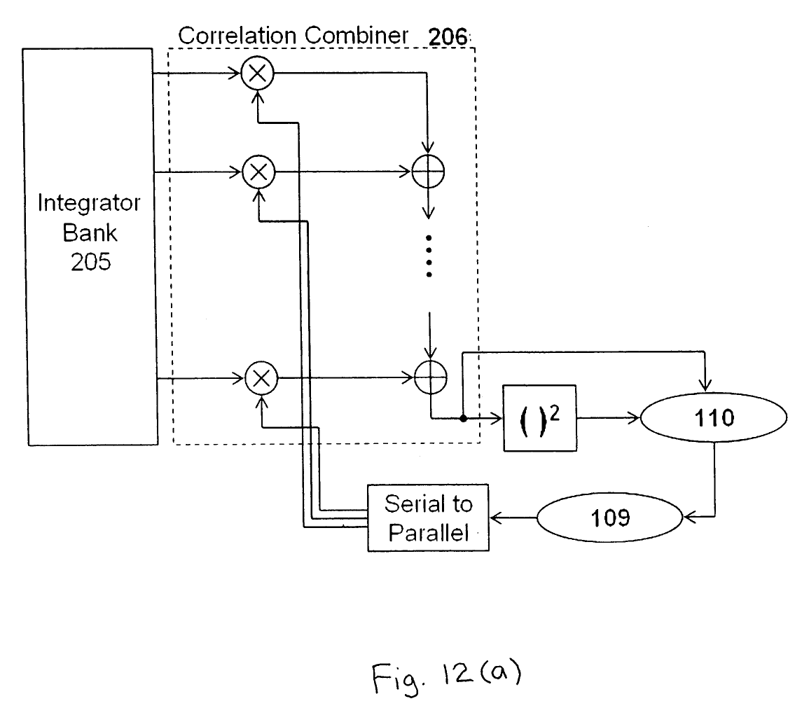

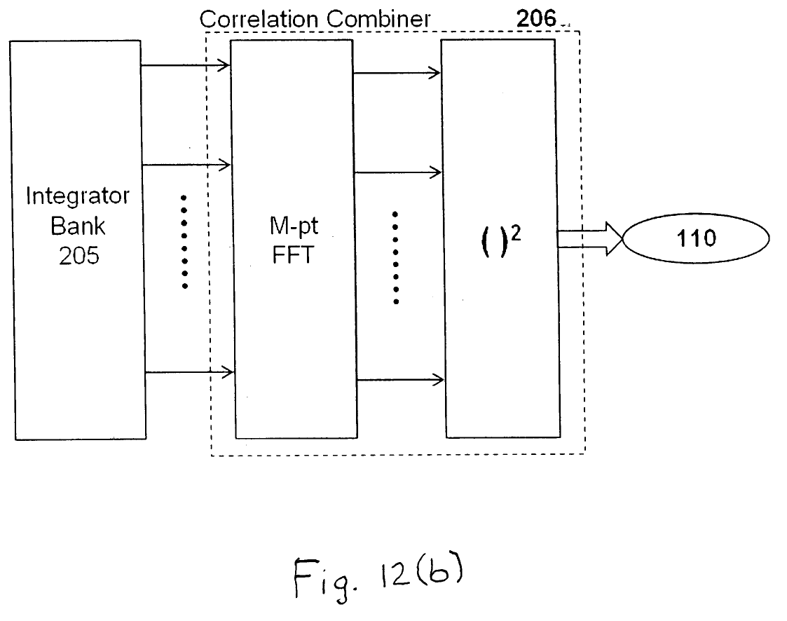

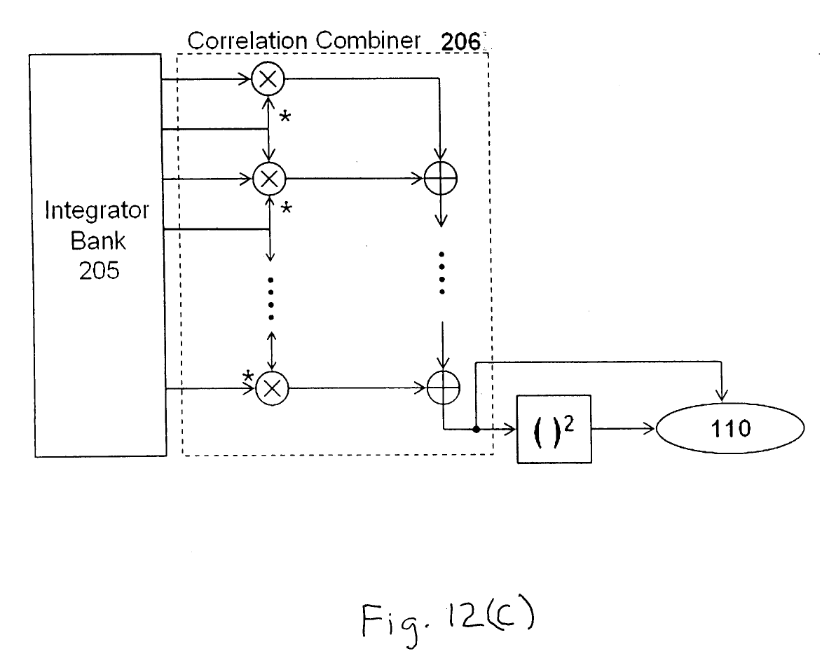

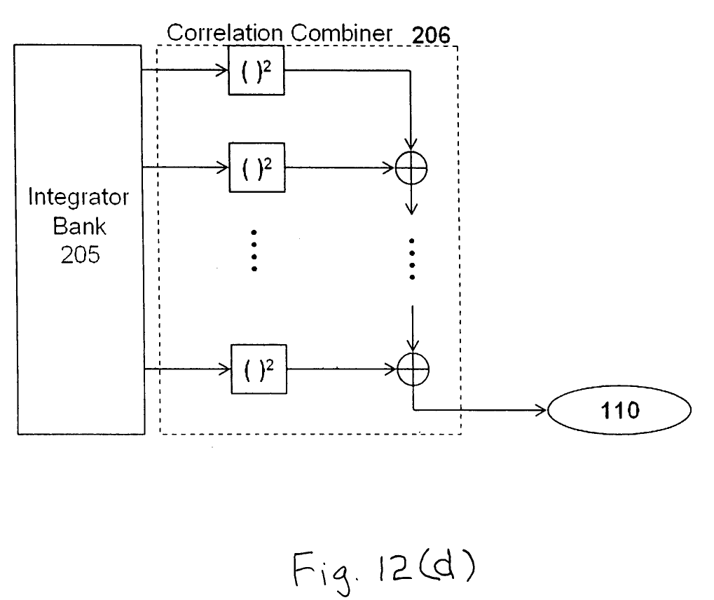

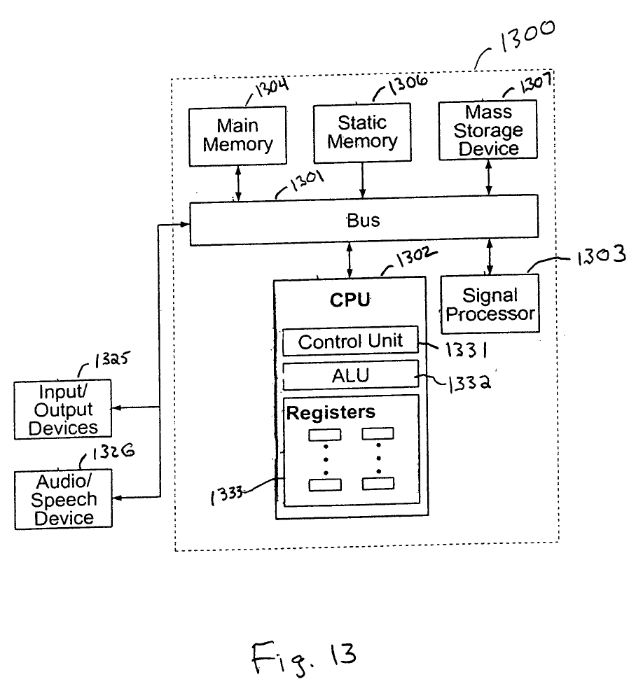

FIGS. 12 (a) through 12 (d) illustrate correlation combining techniques in accordance with alternative embodiments of the invention. For one embodiment of the invention, the individual inputs could be multiplied with a complex residual carrier (as set by the micro controller) and the corresponding outputs could be combined in a coherent fashion. FIG. 12 (a) illustrates coherent correlation combining in accordance with one embodiment of the invention. Alternatively, a frequency domain transform may be used to effect coherent correlation combining by processing the individual inputs from the integrator for combined code/frequency offset estimation. FIG. 12 (b) illustrates the use of a Fast Fourier Transform (FFT) technique to effect coherent correlation combining in accordance with one embodiment of the invention.

FIG. 12 (c) and FIG. 12 (d) illustrate differential combining and noncoherent combining, respectively, and do not require the residual complex carrier module. Such techniques, therefore, aid in frequency independent code offset estimation.

General Matters

Embodiments of the invention include systems and methods to address various disadvantages in SS receiver systems. Various embodiments of the invention may be combined in a single system to address such disadvantages. One embodiment of the invention provides a SS receiver system having initial and secondary pre-filtering blocks together with a bank of one or more CDDs together with corresponding correlators and correlation combiners.

Alternative embodiments of the invention may effect the combining of the integrator outputs through coherent correlation combining, differential correlation combining, non-coherent correlation combining, and combinations thereof, among other combination techniques

While discussed generally in the context of systems employing particular SS techniques (e.g., DSSS systems), embodiments of the invention are equally applicable to systems employing other SS techniques including, but not limited to, frequency-hopping SS (FHSS), PN spreading, time scrambling, chirp, UWB, and combinations of these techniques.

Embodiments of the invention have been described as including various operations. Many of the processes are described in their most basic form, but operations can be added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central site or, alternatively, one or more operations may be performed elsewhere.

As discussed above, embodiments of the invention may employ DSPs or devices having digital processing capabilities. FIG. 13 illustrates a functional block diagram of a digital processing system in accordance with one embodiment of the invention. The components of processing system 1300, shown in FIG. 13 are exemplary in which one or more components may be omitted or added. For example, one or more memory devices may be utilized for processing system 1300.

Referring to FIG. 13, processing system 1300 includes a central processing unit 1302 and a signal processor 1303 coupled to a main memory 1304, static memory 1306, and mass storage device 1307 via bus 1301. In accordance with an embodiment of the invention, main memory 1304 may store a selective communication application, while mass storage device 1307 may store various digital content as discussed above. Processing system 1300 may also be coupled to input/output (I/O) devices 1325, and audio/speech device 1326 via bus 1301. Bus 1301 is a standard system bus for communicating information and signals. CPU 1302 and signal processor 1303 are processing units for processing system 1300. CPU 1302 or signal processor 1303 or both may be used to process information and/or signals for processing system 1300. CPU 1302 includes a control unit 1331, an arithmetic logic unit (ALU) 1332, and several registers 1333, which are used to process information and signals. Signal processor 1303 may also include similar components as CPU 1302.

Main memory 1304 may be, e.g., a random access memory (RAM) or some other dynamic storage device, for storing information or instructions (program code), which are used by CPU 1302 or signal processor 1303. Main memory 1304 may store temporary variables or other intermediate information during execution of instructions by CPU 1302 or signal processor 1303. Static memory 1306, may be, e.g., a read only memory (ROM) and/or other static storage devices, for storing information or instructions, which may also be used by CPU 1302 or signal processor 1303. Mass storage device 1307 may be, e.g., a hard or floppy disk drive or optical disk drive, for storing information or instructions for processing system 1300.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A receiver for receiving spread spectrum signals comprising:
an initial pre-filter to enhance the signal-to-noise ratio of one or more received psuedo baseband samples determined from a received signal;
a bank of one or more CDDs to process the original/enhanced samples, wherein each complex differential detector unit produces a corresponding output signal;
a secondary pre-filter bank consisting of one or more pre-filters, each output signal enhanced by a corresponding pre-filter of the one or more secondary pre-filters;
a modified correlator bank of one or more correlators, each of the one or more correlators correlating an enhanced output signal received from a corresponding secondary pre-filter to produce a correlated output signal; and
one or more correlation combiners for combining the correlated output signal.

2. The receiver of claim 1 wherein the combined correlated output signal exhibits suppressed noise and interference relative to the received signal.

3. The receiver of claim 1, wherein the combined correlated output signal exhibits enhanced auto-correlation side-peak and cross-correlation interference suppression relative to the received signal.

4. The receiver of claim 1 wherein the combined correlated output signal exhibits suppressed time-varying phase relative to the received signal.

5. The receiver of claim 1 wherein the initial pre-filter and each of the one or more secondary pre-filters includes one or more linear delay elements and a summer

6. The receiver of claim 1 wherein the initial pre-filter and each of the one or more secondary pre-filters has a passband response that is periodic over the inverse of a PRN code repetition rate, the inverse of a PRN code repetition rate not less than the passband.

7. The receiver of claim 1 wherein the CDD bank performs a plurality of complex differential detection operations, where each complex differential detection operation using a unique delay parameter, each delay parameter equal to a fractional or integer number of PRN chip periods.

8. The receiver of claim 7 wherein the complex differential detection operations include performing complex delay-and-multiply operations on the enhanced samples.

9. The receiver of claim 1 wherein correlation combining is effected using a combining technique selected from the group of combining techniques consisting of coherent correlation combining, differential correlation combining, non-coherent correlation combining, and combinations thereof.

10. The receiver of claim 9 wherein a coherent correlation combining technique is effected using a frequency domain transform.

11. The receiver of claim 10 wherein the frequency domain transform is a FFT.

12. The receiver of claim 10, wherein individual correlation outputs are used for estimating a residual frequency offset.

13. A method for processing spread spectrum signals comprising:
perform a pre-filtering in the form of delay-and-sum operation on a plurality of received pseudo baseband samples to produced enhanced samples;
perform a delay-and-multiply operation on the original/enhanced sample in each of one or more CDDs, each CDD producing an output signal;
perform additional pre-filtering in the form of one or more delay-and-sum operations on each of the output signals from the CDDs;
perform a modified correlation operation initially by transforming the local PRN code using a similar delay-and-multiply operation and multiplying the subsequent output with the output of each of the corresponding pre-filters ; and
combine the collective outputs of the pre-filters.

14. A method for processing spread spectrum signals comprising:
process received pseudo-baseband samples using a combination of pre-filtering and pluralities of complex differential detection operations to provide pluralities of distinct series of output pseudo-baseband samples.

15. The method of claim 14 wherein the pluralities of distinct series of output pseudo-baseband samples exhibit suppressed noise and interference relative to the received pseudo-baseband samples.

16. The method of claim 14 wherein the pluralities of distinct series of output pseudo-baseband samples exhibit suppressed time-varying phase relative to the received pseudo-baseband samples.

17. The method of claim 14 wherein the pre-filtering process may include linear delay process and a summing process.

18. The method of claim 14 wherein pre-filtering process is effected using a filter having a passband response that is periodic over the inverse of a PRN code repetition rate, the inverse of a PRN code repetition rate not less than the passband.

19. The method of claim 14 wherein each of the CDDs operations includes a plurality of complex differential detection operations, each complex differential detection operation using a unique delay parameter, each delay parameter equal to a fractional or integer number of PRN chip periods.

20. The method of claim 19 wherein the differential detection operations include performing delay-and-multiply operations on the enhanced samples.

21. A machine-readable medium that provides executable instructions, Which when executed by a processor, cause the processor to perform a method, the method comprising:
processing received pseudo-baseband samples using a combination of pre-filtering and pluralities of complex differential detection operations to provide pluralities of distinct series of output pseudo-baseband samples.

22. The machine-readable medium of claim 21 wherein the pluralities of distinct series of output pseudo-baseband samples exhibit suppressed noise and interference relative to the received pseudo-baseband samples.

23. The machine-readable medium of claim 21 wherein the pluralities of distinct series of output pseudo-baseband samples exhibit suppressed time-varying phase relative to the received pseudo-baseband samples.

24. The machine-readable medium of claim 21 wherein the pre-filtering includes a linear delay process and a summing process.

25. The machine-readable medium of claim 21 wherein pre-filtering is effected using a filter having a passband response that is periodic over the inverse of a PRN code repetition rate, the inverse of a PRN code repetition rate not less than the passband.

26. The machine-readable medium of claim 21 wherein each of the CDDs operations includes a plurality of complex differential detection operations, each complex differential detection operation using a unique delay parameter, each delay parameter equal to a fractional or integer number of PRN chip periods.

27. The machine-readable medium of claim 26 wherein the differential detection operations include performing delay-and-multiply operations on the enhanced samples.
